(19) United States
(12) Patent Application Publication
(10) Pub. No.: US 2024/0403051 A1
(43) Pub. Date: Dec. 5, 2024

(54) Instruction Parsing Method and Apparatus, and Electronic Device

(71) Applicants: PEKING UNIVERSITY, Beijing (CN); PEKING UNIVERSITY CHONGQING RESEARCH INSTITUTE OF BIG DATA, Chongqing (CN)

(72) Inventors: Ruo Li, Beijing (CN); Tiao Lu, Beijing (CN)

(21) Appl. No.: 18/291,641

(22) PCT Filed: Sep. 23, 2022
(86) PCT No.: PCT/CN2022/121043

§ 371 Date: Jan. 24, 2024

(30) Foreign Application Priority Data
Jan. 18, 2022 (CN) 202210051959.2

(51) Int. Cl. G06F 9/30

(52) U.S. Cl. CPC G06F 9/30145; G06F 9/30036

(57) ABSTRACT

The disclosure discloses a method for parsing method and device, and an electronic device. The method includes: receiving a target instruction and a parameter processor set, wherein the target instruction includes a target instruction parameter vector, a composition element of the target instruction parameter vector is a target instruction parameter, the parameter processor set includes at least one parameter processor, and the parameter processor consists of a preset to-be-matched command parameter vector and a first preset anonymous function; determining, from the parameter processors, a target parameter processor matching the target instruction parameter in the target instruction parameter vector, and processing the target instruction parameter by using the target parameter processor, to obtain a processing result; and determining, according to the processing result, a processing command corresponding to the target instruction, and executing the processing command.

### TECHNICAL FIELD

The disclosure relates to the technical field of software drawing, and includes a method and device for parsing an instruction, and an electronic device.

### BACKGROUND

The idea of a numerical calculation general-purpose software drawing module is that numerical calculation general-purpose software transmits a drawing command and drawing parameters, a drawing module performs parameter parsing, an image is expressed by using a Canvas-Figure-Axis-Object four-layer tree, and the parameter parsing and processing process is a transformation process of the four-layer tree. After the parameter parsing and processing process are completed, the four-layer tree is traversed and converted into a gnuplot script. Finally, the script is converted into an image by calling a gnuplot program. During this process, parsing and processing drawing commands and parameters are the most complex parts. Since there are many commands and parameters that need to be supported, the code maintenance difficulty may be greatly increased by performing the parameter parsing in a hardcode mode, which is not conducive to the continuous development of modules.

In view of the above problems, an effective solution has not been proposed at present.

### SUMMARY

Embodiments of the disclosure provide a method for parsing instruction and device, and an electronic device, to at least solve the technical problem in the prior art that the code maintenance difficulty is greatly increased by performing parameter parsing in a hardcode mode, which is not conducive to the continuous development of components.

According to one aspect of the embodiments of the disclosure, a method for parsing instruction is provided, including: a target instruction and a parameter processor set are received, wherein the target instruction includes a target instruction parameter. A composition element of the target instruction parameter vector is a target instruction parameter. The parameter processor set includes at least one parameter processor. The parameter processor is consists of a preset to-be-matched command parameter vector and a first preset anonymous function. A target parameter processor matching the target instruction parameter in the target instruction parameter vector is determined from the parameter processor set. The target instruction parameter is processed by using the target parameter processor, to obtain a processing result. A processing command corresponding to the target is determined according to the processing result. And the processing command is executed.

In some embodiments, the step of determining the target parameter processor matching the target instruction parameter, and processing the target instruction parameter by using the target parameter processor includes: each parameter processor in the at least one parameter processor is traversed starting from the first target instruction parameter in the target instruction parameter vector. Then the target parameter processor is determined from the at least one parameter processor based on the preset to-be-matched command parameter vector of each parameter processor. And the target instruction parameter is processed by using the first preset anonymous function in the target parameter processor.

In some embodiments, the step of traversing each parameter processor in the at least one parameter processor starting from the first target instruction parameter in the target instruction parameter vector, includes: a number of elements is determined in the preset to-be-matched command parameter vector corresponding to each parameter processor. Then it is determined whether preceding target instruction parameters match with elements at corresponding positions in the to-be-matched command parameter vector starting from the first target instruction parameter. The number of preceding target instruction parameters is equal to the number of elements. In response to that the preceding target instruction parameters match the elements at the corresponding positions in the to-be-matched command parameter vector, the parameter processor corresponding to the preset to-be-matched command parameter vector is determined to be the target parameter processor. Then starting from the first target instruction parameter that does not match the target parameter in the target parameter vector, it is determined whether preceding target instruction parameters with a quantity equal to the number of elements match elements at corresponding positions in the to-be-matched command parameter vector again. In response to that preceding target instruction parameters with a quantity equal to the number of elements match the elements at the corresponding positions in the to-be-matched command parameter vector, the parameter processor corresponding to the preset to-be-matched command parameter vector is determined to be the target parameter processor, until matched parameter processors are determined for all target instruction parameters.

In some embodiments, the step of determining parameter processor corresponding to the preset to-be-matched command parameter vector to be the target parameter includes: in response to that a plurality of parameter processors are target parameter processors, target parameter processor is selected among the plurality of target parameter processors. Wherein the target parameter processor is the parameter processor having the largest number of matched target instruction parameters among the plurality of target parameter processors.

In some embodiments, the step of determining whether preceding target instruction parameters match elements at corresponding positions in the to-be-matched command parameter vector, includes: a second preset anonymous function corresponding to each element in the to-be-matched command parameter vector is determined. The preceding target instruction parameters are inputted into the second preset anonymous functions. Wherein the second preset anonymous functions is corresponded to the elements at the corresponding positions. Return values are acquired returned by the second preset anonymous functions according to the input target instruction parameters. And it is determined whether the preceding target instruction parameters match the elements at the corresponding positions according to the return values. Wherein the number of the preceding target instruction parameters is equal to the number of elements.

In some embodiments, the step of determining the second preset anonymous function corresponding to each element in the to-be-matched command parameter vector, includes: a plurality of third preset anonymous functions are determined. Then a preset number of third preset anonymous functions are selected from the plurality of third preset anonymous functions. The second preset anonymous function is obtained by performing logical operation on the preset number of third preset anonymous functions. Wherein the logical operation includes at least one of logical and operation, logical or operation, and logical not operation.

In some embodiments, the step of determining the parameter processor corresponding to the preset to-be-matched command parameter vector to be the target parameter processor, includes: an abnormal instruction parameter in the preceding target instruction parameters is searched in the preceding target instruction parameters with a quantity equal to the number of elements. Wherein the abnormal instruction parameter is an instruction parameter that does not match any parameter processor. In response to that there is an abnormal instruction parameter, the abnormal instruction parameter is deleted. Then preceding target instruction parameters are re-selected of which the number is equal the number of elements. The preceding target instruction parameters are determined whether match the elements at the corresponding positions in the to-be-matched command parameter vector. And in response to that the preceding target instruction parameters match the elements at the corresponding positions in the to-be-matched command parameter vector, the target parameter processor is determined corresponding to the preset to-be-matched command parameter vector from the parameter processor.

According to another aspect of the disclosed embodiments, an instruction parsing apparatus is further provided, including: a receiving component for receiving a target instruction and a parameter processor set. Wherein the target instruction includes a target instruction parameter vector. A composition element of the target instruction parameter vector is a target instruction parameter. The parameter processor set includes at least one parameter processor. The parameter processor consists of a preset to-be-matched command parameter vector and a first preset anonymous function. A processing component, configured to determine, from the parameter processors, a target parameter processor matching the target instruction parameter in the target instruction parameter vector. Process the target instruction parameter by using the target parameter processor, to obtain a processing result. An execution component, configured to determine, according to the processing result, a processing command corresponding to the target instruction. And execute the processing command.

According to another aspect of the disclosed embodiments, a nonvolatile storage medium is provided, wherein the nonvolatile storage medium includes a stored program, and when running, the program controls a device where the nonvolatile storage medium is located to execute the method for parsing instruction.

According to another aspect of the disclosed embodiments, an electronic device is provided, wherein the electronic device includes a processor. The processor is used for running a program, and the program executes the method for parsing instructions at runtime.

In the disclosed embodiments, a target instruction and a parameter processor set are received, wherein the target instruction includes a target instruction parameter. A composition element of the target instruction parameter vector is a target instruction parameter. The parameter processor set includes at least one parameter processor. The parameter processor is composed of the consists of a preset to-be-matched command parameter vector and a first preset anonymous function. A target parameter processor matching the target instruction parameter is determined from the parameter processor set. The target instruction parameter is processed by using the target parameter processor, and a processing result is obtained. According to the processing result, the processing command corresponding to the target is determined and executed. Thereby the technical problem is solved in the prior art that code maintenance difficulty is greatly increased by performing parameter parsing in a hard encoding mode, which is not conducive to the continuous development of components. Finding a parameter processor that matches the target instruction parameters and utilizing this processor to parse the target instruction parameters can effectively solve the aforementioned technical problems.

### BRIEF DESCRIPTION OF THE DRAWINGS

The drawings described herein are used to provide a further understanding of the disclosure and constitute a part of the disclosure, and schematic embodiments of the disclosure and descriptions thereof are used to explain the disclosure, and do not constitute improper limitations to the disclosure. In the drawings:

FIG. 1 is a schematic flowchart of a method for parsing instruction according to an embodiment of the disclosure;

FIG. 2 is a schematic flowchart of a complete instruction parsing process according to an embodiment of the disclosure;

FIG. 3 is a schematic structural diagram of an instruction parsing apparatus according to an embodiment of the present application;

FIG. 4 is a schematic structural diagram of a computer device according to an embodiment of the disclosure.

### DETAILED DESCRIPTION OF THE EMBODIMENTS

In order to enable those skilled in the art may better understand the disclosed solutions, a clear and complete description of technical solutions in the disclosed embodiments will be given below, in combination with the accompanying drawings. Apparently, the embodiments described below are merely a part of the disclosed embodiments, not the whole. All of other embodiments, obtained by those ordinary skilled in the art based on the disclosed embodiments without any creative effort, shall fall within the protection scope of the disclosure.

It should be noted that, the terms such as “first” and “second” in the specification, claims and the above-mentioned drawings of the disclosure are used for distinguishing similar objects, and are not necessarily used for describing a specific sequence or precedence order. It should be understood that the data used in this way may be interchanged under appropriate circumstances, so that the embodiments disclosed herein may be implemented in a different order than those illustrated or described herein. Furthermore, the terms “including” and “having”, and any variations thereof are intended to cover non-exclusive inclusions. For example, processes, methods, systems, products or devices including a series of steps or units are not necessarily limited to those clearly listed steps or units, but may include other steps or units that are not clearly listed or are inherent to these processes, methods, systems, products or devices.

According to the disclosed embodiments, a method embodiment of an instruction parsing instruction is provided. It should be noted that the steps shown in the flowchart of the accompanying drawings may be executed in a computer system such as a group of computer-executable instructions, and although a logical sequence is shown in the flowchart, in some cases, the illustrated or described steps may be executed in a different order from here.

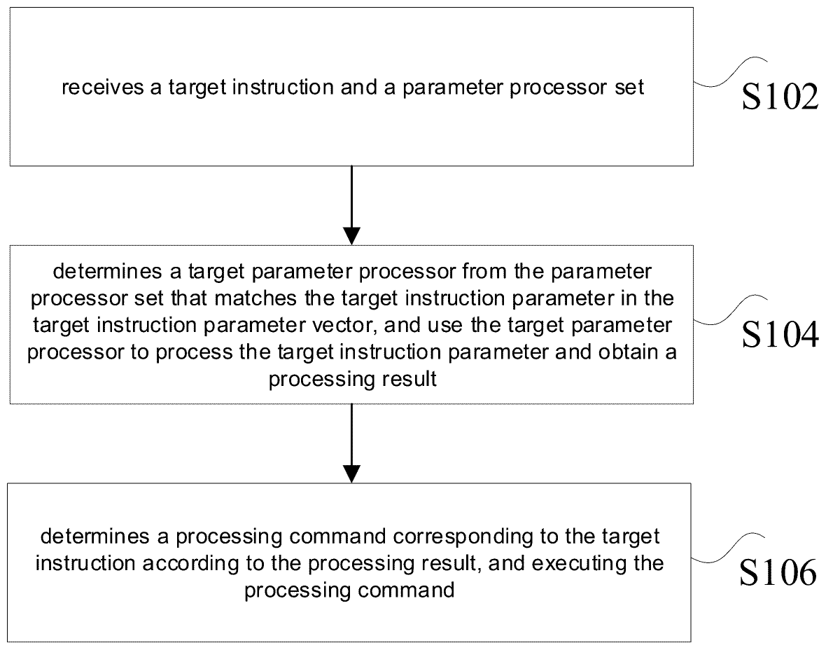

FIG. 1 shows a method for parsing instruction according to the present disclosed embodiment which includes the following steps:

Step S102, receives a target instruction and a parameter processor set, wherein the target instruction includes a target instruction parameter vector. The composition element of the target instruction parameter vector is a target instruction parameter. The parameter processor set includes at least one parameter processor, and the parameter processor consists of a preset to-be-matched command parameter vector and a first preset anonymous function.

In some embodiments of the present disclosure, in addition to the target instruction parameter vector (args) and the parameter processor set (handlers). The target instruction may further include a command name (cmd) and the number of command parameters (argc).

In some embodiments of the present disclosure, the first preset anonymous function in the parameter processor may be an anonymous function. Anonymous function are stored as a type of variable (function_handle). And the preset to-be-matched command parameter vector is a pre-registered vector.

In some embodiments of the present disclosure, the pre-registration refers to adding the preset to-be-matched command parameter vector into a Minglin processor during a program initialization stage. Then a command processor is directly called with the preset to-be-matched command parameter vector added to perform command processing during subsequent actual command processing.

Step S104, determines a target parameter processor from the parameter processor set that matches the target instruction parameter in the target instruction parameter vector, and use the target parameter processor to process the target instruction parameter and obtain a processing result.

In some embodiments of the present disclosure, the specific mode of determining the target parameter processor matching the target instruction parameter in the target instruction parameter vector, and processing the target instruction parameter by using the target parameter processor, to obtain the processing result is as follows: each parameter processor in the at least one parameter processor is traversed starting from the first target instruction parameter in the target instruction parameter vector. Then the target parameter processor is determined from the at least one parameter processor based on the preset to-be-matched command parameter vector of each parameter processor. And the target instruction parameter is processed by using the first preset anonymous function in the target parameter processor.

In some embodiments of the present disclosure, the target instruction may be any target instruction, which is set based on user requirements. When the command is a “hold command”, the hold command may transmit a character string parameter with a value of on or off. When processing the hold command, the command processor needs to actually process hold (‘on’) or hold (‘off’) after matching the parameters. The processing herein is, in fact, to modify a global variable in one program, to change the processing mode of the components of a subsequent drawing command. In a hold off state, before each drawing, the module needs to clear up the currently drawn graph, while the component does not need to clear up the currently drawn graph in a hold on state.

In some embodiments of the present disclosure, the step: traversing each parameter processor in the at least one parameter processor starting from the first target instruction parameter in the target instruction parameter vector, includes: a number of elements is determined in the preset to-be-matched command parameter vector corresponding to each parameter processor. Then it is determined whether preceding target instruction parameters match with elements at corresponding positions in the to-be-matched command parameter vector starting from the first target instruction parameter. The number of preceding target instruction parameters is equal to the number of elements. In response to that the preceding target instruction parameters match the elements at the corresponding positions in the to-be-matched command parameter vector, the parameter processor corresponding to the preset to-be-matched command parameter vector is determined to be the target parameter processor. Then starting from the first target instruction parameter that does not match the target parameter in the target parameter vector, it is determined whether preceding target instruction parameters with a quantity equal to the number of elements match the elements at corresponding positions in the to-be-matched command parameter vector again. In response to that preceding target instruction parameters with a quantity equal to the number of elements match the elements at the corresponding positions in the to-be-matched command parameter vector, the parameter processor corresponding to the preset to-be-matched command parameter vector is determined to be the target parameter processor, until matched parameter processors are determined for all target instruction parameters.

In some embodiments of the present disclosure, in response to that a plurality of parameter processors are target parameter processors, target parameter processor is selected among the plurality of target parameter processors. Wherein the target parameter processor is the parameter processor having the largest number of matched target instruction parameters among the plurality of target parameter processors. In some embodiments of the present disclosure, the specific process of the matching process is as follows: starting from the 0th element of the command parameter vector args (starting from 0 in a subscript of a C++ array), all command processors handle in handlers are traversed before all parameters are matched. During the process of traversing each handle, handle.params is traversed (i.e., the preset to-be-matched command parameter vector), and it is checked whether a corresponding element in the args satisfies a condition to be satisfied by a corresponding element in the handle.params (the condition herein is implemented by an anonymous function of which the function prototype is bool (void*)). After the handler satisfying the condition is found (in response to that if it is not found, the above process is repeated starting from the element of the next args), the handler is assigned to matched_handler (i.e., selecting the anonymous function of the target parameter processor to process the parameters). Then matched_handler.handle is used to process the matched command parameter, and starting from unprocessed command parameters, the above process is repeated until all parameters are processed.

In some embodiments of the present disclosure, the step of determining whether the preceding target instruction parameters of which the number is the number of elements match the elements at the corresponding positions in the to-be-matched command parameter vector, includes: a second preset anonymous function corresponding to each element in the to-be-matched command parameter vector is determined. The preceding target instruction parameters are inputted into the second preset anonymous functions. Wherein the second preset anonymous functions is corresponded to the elements at the corresponding positions. Return values are acquired returned by the second preset anonymous functions according to the input target instruction parameters. And it is determined whether the preceding target instruction parameters match the elements at the corresponding positions according to the return values. Wherein the number of the preceding target instruction parameters is equal to the number of elements.

In some embodiments of the present disclosure, the step of determining the second preset anonymous function corresponding to each element in the to-be-matched command parameter vector, includes: a plurality of third preset anonymous functions are determined. Then a preset number of third preset anonymous functions are selected from the plurality of third preset anonymous functions. The second preset anonymous function is obtained by performing logical operation on the preset number of third preset anonymous functions. Wherein the logical operation includes at least one of logical and operation, logical or operation, and logical not operation.

In some embodiments of the present disclosure, the step of determining, to be the target parameter processor, the parameter processor corresponding to the preset to-be-matched command parameter vector, includes: an abnormal instruction parameter in the preceding target instruction parameters is searched in the preceding target instruction parameters with a quantity equal to the number of elements. Wherein the abnormal instruction parameter is an instruction parameter that does not match any parameter processor. In response to that there is an abnormal instruction parameter, the abnormal instruction parameter is deleted. Then preceding target instruction parameters are re-selected of which the number is equal the number of elements. The preceding target instruction parameters are determined whether match the elements at the corresponding positions in the to-be-matched command parameter vector. And in response to that the preceding target instruction parameters match the elements at the corresponding positions in the to-be-matched command parameter vector, the target parameter processor is determined corresponding to the preset to-be-matched command parameter vector from the parameter processor.

Step S106, determines a processing command corresponding to the target instruction according to the processing result, and executing the processing command.

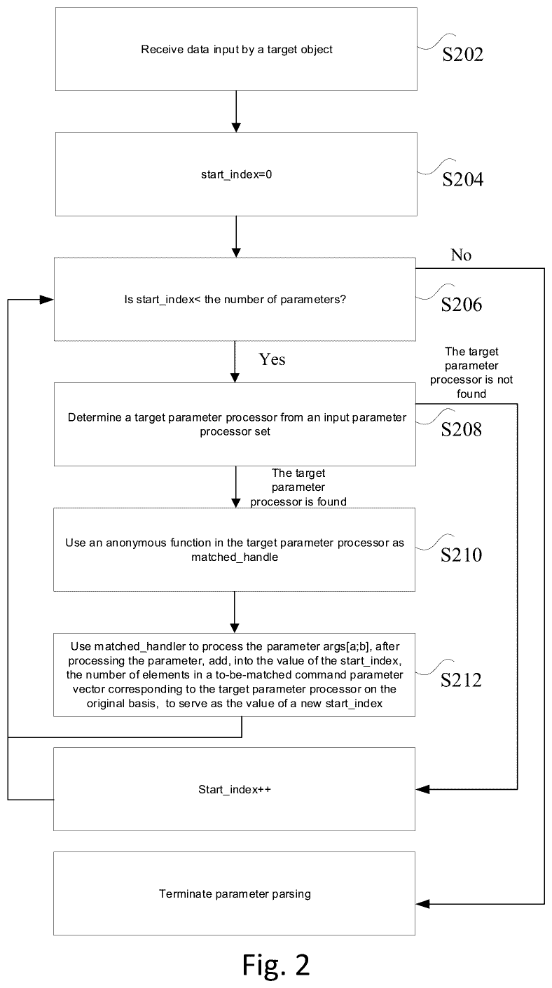

In some embodiments of the present disclosure, the image processing mode described in FIG. 1 may be implemented by a target function, which is self-defined by a target object. When the target function is a target function created by the target object using C++ remaining elements, the specific process when the target function executes the method for parsing instruction shown in FIG. 1 is shown in FIG. 2, and includes the following steps:

First, after receiving a parameter parsing instruction, the target function first executes step S202 to receive the input data of the target object. Wherein the input data includes a command name, a parameter vector, the number of parameters, and a parameter processor set. The number of parameters is used for determining the number of elements in the parameter vector, and the number of elements in the parameter vector represents different parameters.

Then, the target function executes step S204 to assign the value of a custom variable start_index to zero. Wherein the start_index represents the subscript of the currently processed parameter. And since the C++ language starts to count from 0, the start_index is assigned an initial value of zero. It may be understood that, when the target object uses languages of other types, the initial value of the start_index may also be other values.

Next, the target function executes step S206 to judge whether the start_index is less than argc (the number of parameters). In response to that the judgement result is that the start_index is not less than argc, the target function terminates parameter parsing, and controls a device running the target function to execute a command corresponding to the input data. In response to that the judgement result is that the start_index is less than argc, the target function continues to execute step S208 to determine a target parameter processor from an input parameter processor set. In response to that no matched target parameter processor is found, the target function adds 1 to the start_index, and executes step S206 again. In response to that the matched target parameter processor is found, the target function executes step S210 to use an anonymous function in the target parameter processor as matched_handler. Then step S212 is executed to use the matched_handler to process the parameter args [a;b]. After processing the parameter, adds, into the value of the start_index, the number of elements in a to-be-matched command parameter vector corresponding to the target parameter processor on the original basis, to serve as the value of a new start_index. And step S206 is executed again. Wherein a=start_index, b=start_index+matched_handler.params.size( ) that is, b=start_index+the number of elements in the to-be-matched command parameter vector corresponding to the target parameter processor.

By means of a target instruction and a parameter processor set are received, wherein the target instruction includes a target instruction parameter. A composition element of the target instruction parameter vector is a target instruction parameter. The parameter processor set includes at least one parameter processor. The parameter processor consists of a preset to-be-matched command parameter vector and a first preset anonymous function. A target parameter processor matching the target instruction parameter in the target instruction parameter vector is determined from the parameter processor set. The target instruction parameter is processed by using the target parameter processor, to obtain the processing result. A processing command corresponding to the target is determined according to the processing result. And the processing command is executed. A table driving method is combined with a greedy policy. And lambda (anonymous function) expression introduced by C++ 11 is fully utilized to extremely effectively separate the implementation codes of a plurality of parameters of the command. So that the parameters have orthogonality. And moreover, the present method realizes a unified parameter parsing framework. So that when a developer implements a new command, complex parameter parsing may be effectively supported only by using the framework, thereby improving the development efficiency and the maintainability of the codes.

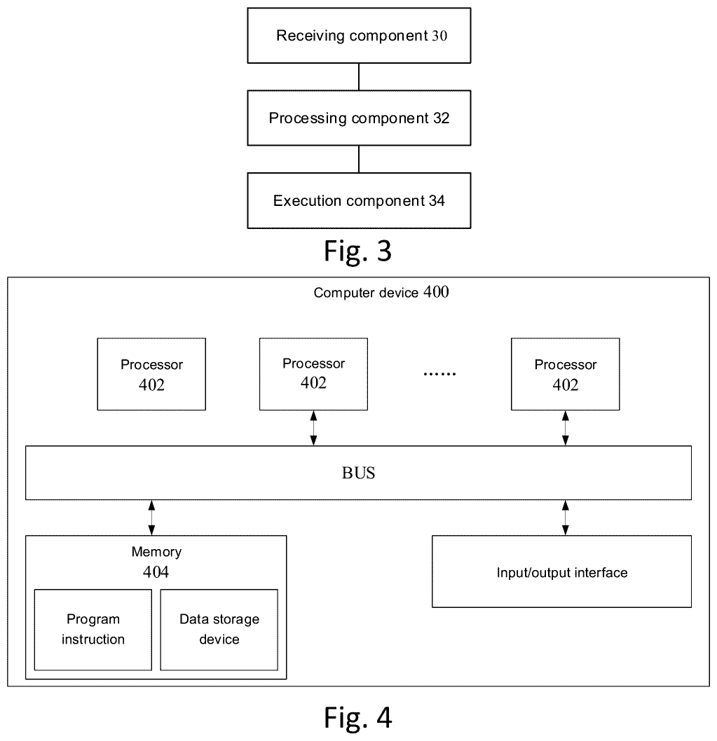

According to the embodiments of the disclosure, an apparatus embodiment of an instruction parsing device is provided. FIG. 3 shows the instruction parsing device provided according to an embodiment of the disclosure, and as shown in FIG. 3, the instruction parsing device includes: a receiving component 30, configured to receive a target instruction and a parameter processor set, wherein the target instruction includes a target instruction parameter vector, a composition element of the target instruction parameter vector is a target instruction parameter, the parameter processor set includes at least one parameter processor, and the parameter processor consists of a preset to-be-matched command parameter vector and a first preset anonymous function; a processing component 32, configured to determine, from the parameter processors, a target parameter processor matching the target instruction parameter in the target instruction parameter vector, and process the target instruction parameter by using the target parameter processor, to obtain a processing result; and an execution component 34, configured to determine, according to the processing result, a processing command corresponding to the target instruction, and execute the processing command.

It should be noted that, the instruction parsing device shown in FIG. 3 may be used for executing the a method for parsing instruction shown in FIG. 1, therefore, the related explanation of the a method for parsing instruction shown in FIG. 1 is also applicable to the instruction parsing device shown in FIG. 3, and thus details are not described herein again.

According to the embodiments of the disclosure, a storage medium embodiment of a nonvolatile storage medium is provided. The nonvolatile storage medium includes a stored program, wherein when running, the program controls a device where the nonvolatile storage medium is located to execute the following a method for parsing instruction: receiving a target instruction and a parameter processor set, wherein the target instruction includes a target instruction parameter vector, a composition element of the target instruction parameter vector is a target instruction parameter, the parameter processor set includes at least one parameter processor, and the parameter processor consists of a preset to-be-matched command parameter vector and a first preset anonymous function; determining, from the parameter processors set, a target parameter processor matching the target instruction parameter in the target instruction parameter vector, and processing the target instruction parameter by using the target parameter processor, to obtain a processing result; and determining, according to the processing result, a processing command corresponding to the target instruction, and executing the processing command.

According to the embodiments of the disclosure, an embodiment of an electronic device is provided. The electronic device includes a processor, and the processor is used for running a program, wherein the program, executes, when running, the following a method for parsing instruction: receiving a target instruction and a parameter processor set, wherein the target instruction includes a target instruction parameter vector, a composition element of the target instruction parameter vector is a target instruction parameter, the parameter processor set includes at least one parameter processor and the parameter processor consists of a preset to-be-matched command parameter vector and a first preset anonymous function; determining, from the parameter processor set, a target parameter processor matching the target instruction parameter in the target instruction parameter vector, and processing the target instruction parameter by using the target parameter processor, to obtain a processing result; and determining, according to the processing result, a processing command corresponding to the target instruction, and executing the processing command.

According to the embodiments of the disclosure, an embodiment of a computer terminal is further provided. FIG. 4 is a schematic structural diagram of a computer device 400 shown according to an embodiment of the disclosure.

In an exemplary embodiment, a computer-readable storage medium including an instruction is further provided, for example, a memory 404 including an instruction, and the instruction may be executed by a processor 402 of the device 400 to execute the following a method for parsing instruction: receiving a target instruction and a parameter processor set, wherein the target instruction includes a target instruction parameter vector, a composition element of the target instruction parameter vector is a target instruction parameter, the parameter processor set includes at least one parameter processor, and the parameter processor consists of a preset to-be-matched command parameter vector and a first preset anonymous function; determining, from the parameter processor set, a target parameter processor matching the target instruction parameter in the target instruction parameter vector, and processing the target instruction parameter by using the target parameter processor, to obtain a processing result; and determining, according to the processing result, a processing command corresponding to the target instruction, and executing the processing command.

The serial numbers of the embodiments of the disclosure are only for description, and do not represent the advantages or disadvantages of the embodiments.

In the above embodiments of the disclosure, the description of each embodiment has its own emphasis. For parts that are not described in detail in a certain embodiment, reference may be made to related descriptions of other embodiments.

In the embodiments provided by the disclosure, it should be understood that, the disclosed technical content may be implemented in other manners. The device embodiments described above are merely exemplary. For example, the division of the units is only a logical function division, there may be other division manners in practical implementation, for example, a plurality of units or components may be combined or integrated to another system, or some features may be omitted or not executed. From another point of view, the displayed or discussed mutual coupling or direct coupling or communication connection may be indirect coupling or communication connection of units or modules by means of some interfaces, and may be in electrical or other forms.

The units described as separate components may be separated physically or not, components displayed as units may be physical units or not, namely, maybe located in one place, or may also be distributed on a plurality of units. A part of or all of the units may be selected to implement the purposes of the solutions in the present embodiment according to actual demands.

In addition, the functional units in various embodiments of the present disclosure may be integrated into one processing unit. Either the units individually exist physically, or two or more units are integrated in one unit. The integrated unit may be implemented in the form of hardware, and software functional unit.

In response to that the integrated unit is implemented in the form of the software functional unit and is sold or used as an independent product, it may be stored in a computer-readable storage medium. Based on this understanding, the technical solutions of the disclosure substantially, or the part contributing to the prior art, or part of or all the technical solutions may be implemented in the form of a software product. The computer software product is stored in a storage medium, which includes several instructions for enabling a computer device (which may be a personnel computer, a server, or a network device or the like) to execute all or part of the steps of the method in various embodiments of the disclosure. The foregoing storage medium includes a variety of media capable of storing program codes, such as a USB disk, a read-only memory (ROM, Read-Only Memory), a random access memory (RAM, Random Access Memory), a mobile hard disk, a magnetic disk, or an optical disk.

The foregoing descriptions are merely specific embody ments of the present disclosure. It should be pointed out that, those ordinary skilled in the art may make several improvements and modifications without departing from the principles of the disclosure, and these improvements and modifications should also be regarded as the protection scope of the present application.

### INDUSTRIAL APPLICABILITY

The solutions provided in the disclosed embodiments may be applied to the field of software drawings. In the disclosed embodiments by matching the corresponding parameter processor with the target instruction parameter, and using the parameter processor to process the matched target instruction parameter, the purpose of efficiently parsing the target instruction is achieved, and the technical effect of realizing the implementation efficiency and maintainability of parameter parsing under complex conditions is achieved. Thereby solving the technical problem in the prior art that code maintenance difficulty is greatly increased by performing parameter parsing in a hard encoding mode, which is not conducive to the continuous development of components.

1. A method for parsing an instruction, comprising:
receiving a target instruction and a parameter processor set, wherein the target instruction comprises a target instruction parameter vector, a composition element of the target instruction parameter vector is a target instruction parameter, the parameter processor set comprises at least one parameter processor, and the parameter processor consists of a preset to-be-matched command parameter vector and a first preset anonymous function;
determining, from the parameter processor set, a target parameter processor matching the target instruction parameter in the target instruction parameter vector, and processing the target instruction parameter by using the target parameter processor, to obtain a processing result; and
determining, according to the processing result, a processing command corresponding to the target instruction, and executing the processing command.

2. The method for parsing an instruction as claimed in claim 1, wherein the step of determining the target parameter processor matching the target instruction parameter in the target instruction parameter vector, and processing the target instruction parameter by using the target parameter processor, to obtain the processing result comprises:
starting from the first target instruction parameter in the target instruction parameter vector, traversing each parameter processor in the at least one parameter processor, and determining the target parameter processor from the at least one parameter processor based on the preset to-be-matched command parameter vector of each parameter processor;
processing the target instruction parameter matching the target parameter processor by using the first preset anonymous function in the target parameter processor.

3. The method for parsing an instruction as claimed in claim 2, wherein the step of starting from the first target instruction parameter in the target instruction parameter vector, traversing each parameter processor in the at least one parameter processor, and determining the target parameter processor from the at least one parameter processor based on the preset to-be-matched command parameter vector of each parameter processor, comprises:
determining a number of elements in the preset to-be-matched command parameter vector corresponding to each parameter processor;
starting from the first target instruction parameter, determining whether preceding target instruction parameters match elements at corresponding positions in the to-be-matched command parameter vector, the number of preceding target instruction parameters is the number of elements, and in response to that the preceding target instruction parameters of which the number is the number of elements match the elements at the corresponding positions in the to-be-matched command parameter vector, determining the parameter processor corresponding to the preset to-be-matched command parameter vector to be the target parameter processor;
starting from the first target instruction parameter that does not match the target parameter processor in the target parameter vector, determining whether the preceding target instruction parameters of which the number is the number of elements match the elements at the corresponding positions in the to-be-matched command parameter vector again, and in response to that the preceding target instruction parameters of which the number is the number of elements match the elements at the corresponding positions in the to-be-matched command parameter vector, determining the parameter processor corresponding to the preset to-be-matched command parameter vector to be the target parameter processor, until matched parameter processors are determined for all target instruction parameters.

4. The method for parsing an instruction as claimed in claim 3, wherein the step of determining the parameter processor corresponding to the preset to-be-matched command parameter vector to be the target parameter processor comprises:
in response to that a plurality of parameter processors are target parameter processors, selecting, to be the target parameter processor, the parameter processor having the largest number of matched target instruction parameters among the plurality of target parameter processors.

5. The method for parsing an instruction as claimed in claim 3, wherein the step: determining whether the preceding target instruction parameters of which the number is the number of elements match the elements at the corresponding positions in the to-be-matched command parameter vector, comprises:
determining a second preset anonymous function corresponding to each element in the to-be-matched command parameter vector;
inputting the preceding target instruction parameters of which the number is the number of elements into the second preset anonymous functions corresponding to the elements at the corresponding positions, and acquiring return values returned by the second preset anonymous functions according to the input target instruction parameters;
determining, according to the return values, whether the preceding target instruction parameters of which the number is the number of elements match the elements at the corresponding positions.

6. The method for parsing an instruction as claimed in claim 5, wherein the step of determining the second preset anonymous function corresponding to each element in the to-be-matched command parameter vector, comprises:
determining a plurality of third preset anonymous functions;
selecting a preset number of third preset anonymous functions from the plurality of third preset anonymous functions, and performing logical operation on the preset number of third preset anonymous functions, to obtain the second preset anonymous function, wherein the logical operation comprises at least one of logical and operation, logical or operation, and logical not operation.

7. The method for parsing an instruction as claimed in claim 3, wherein the step: determining the parameter processor corresponding to the preset to-be-matched command parameter vector to be the target parameter processor, comprises:
determining whether there is an abnormal instruction parameter in the preceding target instruction parameters of which the number is the number of elements, wherein the abnormal instruction parameter is an instruction parameter that does not match any parameter processor; and
in response to that there is an abnormal instruction parameter, deleting the abnormal instruction parameter, re-selecting preceding target instruction parameters of which the number is the number of elements, determining whether the preceding target instruction parameters of which the number is the number of elements match the elements at the corresponding positions in the to-be-matched command parameter vector, and in response to that the preceding target instruction parameters of which the number is the number of elements match the elements at the corresponding positions in the to-be-matched command parameter vector, determining, to be the target parameter processor, the parameter processor corresponding to the preset to-be-matched command parameter vector.

8. A device for parsing an instruction, comprising:
a receiving component, configured to receive a target instruction and a parameter processor set, wherein the target instruction comprises a target instruction parameter vector, a composition element of the target instruction parameter vector is a target instruction parameter, the parameter processor set comprises at least one parameter processor, and the parameter processor consists of a preset to-be-matched command parameter vector and a first preset anonymous function;
a processing component, configured to determine, from the parameter processors, a target parameter processor matching the target instruction parameter in the target instruction parameter vector, and process the target instruction parameter by using the target parameter processor, to obtain a processing result; and
an execution component, configured to determine, according to the processing result, a processing command corresponding to the target instruction, and execute the processing command.

9-10. (canceled)

11. The method for parsing instruction as claimed in claim 1, wherein the target instruction comprises a command name and a number of command parameters.

12. The method for parsing instruction as claimed in claim 1, wherein the first preset anonymous function in the parameter processor is an anonymous function of which the type is handle, and the preset to-be-matched command parameter vector is a pre-registered vector.
